(19) United States
(12) Patent Application Publication
(10) Pub. No.: US 2016/0144648 A1
(43) Pub. Date: May 26, 2016

(54) LITHOGRAPHIC PRINTING PLATE PRECURSOR AND METHOD FOR PRODUCING SAME

(71) Applicant: FUJIFILM Corporation, Tokyo (JP)

(72) Inventor: Koji WARIISHI, Haibara-gun (JP)

(73) Assignee: FUJIFILM Corporation, Tokyo (JP)

(21) Appl. No.: 15/000,335

(22) Filed: Jan. 19, 2016

Related U.S. Application Data
(63) Continuation of application No. PCT/JP2014/067273, filed on Jun. 27, 2014.

(30) Foreign Application Priority Data
Jul. 18, 2013 (JP) 2013-149861

(51) Int. Cl. B41N 1/14; B41C 1/10

(52) U.S. Cl. CPC B41N 1/14; B41C 1/10

(57) ABSTRACT

Provided is a lithographic printing plate precursor having extremely excellent on-board developability while maintaining printing durability and having excellent preservation stability, by a lithographic printing plate precursor including, on a support, an image recording layer containing (A) a thermoplastic fine particle polymer; (B) an infrared ray absorption agent; and (C) a polyglycerol compound, in which the polyglycerol compound is a compound having three or more structural units selected from structural units expressed by General Formulae (1) and (2) below,

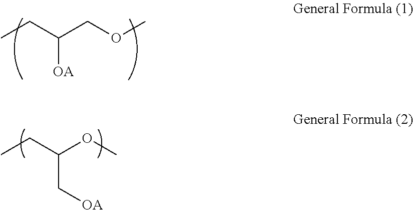

where General Formulae (1) and (2), A represents a hydrogen atom, an alkyl group having 1 to 4 carbon atoms, or an alkyl carbonyl group having 2 to 5 carbon atoms.

### CROSS REFERENCE TO RELATED APPLICATION

This is a continuation of International Application No. PCT/JP2014/067273 filed on Jun. 27, 2014, and claims priority from Japanese Patent Application No. 2013-149861 filed on Jul. 18, 2013, the entire disclosures of which are incorporated herein by reference.

### BACKGROUND OF THE INVENTION

1. Field of the Invention

The present invention relates to a lithographic printing plate precursor and a method for producing the same. Particularly, a lithographic printing plate precursor that can perform image recording and on-board development using various lasers based on digital signals and a method for producing the same.

2. Description of the Related Art

The lithographic printing plate includes a lipophilic image portion that stores ink in a printing process and a hydrophilic non-image portion that stores dampening water. The lithographic printing uses characteristics in which water and oil ink are repellent to each other, causing a lipophilic image portion of a lithographic printing plate and a hydrophilic non-image portion respectively as an ink storing portion and a dampening water storing portion (ink non-storing portion), to cause difference of adhesiveness of ink on the surface of the lithographic printing plate, inking only an image portion, transferring ink to a printing target medium such as paper, and perform printing.

In the related art, a lithographic printing plate is obtained by performing image exposure through a mask such as a lithographic film on the lithographic printing plate precursor by using lithographic printing plate precursor (PS plate) having a lipophilic photosensitive resin layer (image recording layer, image forming layer) on a hydrophilic support, performing a development process using an alkaline developer or the like, leaving an image recording layer corresponding to the image portion, and dissolving and removing an unnecessary image recording layer corresponding to a non-image portion.

A plate producing step of producing a lithographic printing plate from a lithographic printing plate precursor is simplified. Therefore, recently, with respect to the image exposure, the lithographic printing plate can be obtained by a computer-to-plate (CTP) technique. That is, a lithographic printing plate can be obtained by using a laser or a laser diode, without interposing a lithographic film therebetween, directly scanning and exposing a lithographic printing plate precursor, and performing a development process.

Recently, in the plate producing step of a lithographic printing plate precursor, there is suggested a method called on-board development of removing a non-image portion on a printing machine, after image exposure by using an image recording layer of which an unnecessary portion of a lithographic printing plate precursor can be removed in a normal printing step and obtaining a lithographic printing plate. According to this method, a lithographic printing plate can be obtained by removing a non-image portion by using at least one of printing ink and dampening water on the printing machine after image exposure by causing a highly convergent radiant ray such as laser light to carry the digitalized image information and scanning and exposing the lithographic printing plate precursor, in response to a digitalizing technique of electronically processing image information by a computer and accumulating and outputting the image information. Accordingly, a development process step of lithographic printing plate, which is a necessary step in a printing industry in the related art, can be omitted, and thus a plate producing operation can be performed in a completely dry environment (liquid is not used), such that it is possible to greatly reduce the load of operations and environments.

The lithographic printing plate precursor which is suitable for on-board development is a lithographic printing plate precursor (hereinafter, referred to as an on-board development-type lithographic printing plate precursor) that has an image recording layer of which a non-image portion can be removed by any one of printing ink and dampening water on the printing machine.

As the on-board development-type lithographic printing plate precursor, a lithographic printing plate precursor (for example, JP2002-287334A) that has an image recording layer containing an infrared ray absorption agent, a polymerization initiator, and a polymerizable compound on a support and a lithographic printing plate precursor (for example, JP2938397B) that has an image recording layer containing an infrared ray absorption agent and thermoplastic polymer particles on a support are known.

With respect to the lithographic printing plate precursor that has the image recording layer containing the infrared ray absorption agent and the thermoplastic polymer particles on the support, image exposure with an infrared ray laser is performed and the thermoplastic polymer particles are fused by heat, and thus an image is formed. With respect to the thermal fusion-type lithographic printing plate precursor, in order to enhance printing durability, it is required that image strength by increasing thermal fusion efficiency is increased. However, if thermal fusion efficiency is enhanced, fusion between thermoplastic polymer particles easily occurs over time and thus on-board developability decreases. That is, it is difficult to enhance both printing durability and on-board developability.

In view of this circumstance, for example, JP2002-365789A discloses causing a compound having an ethylene oxide chain to be contained in an image forming layer, and JP2004-174980A discloses causing thermal fusable fine particle dispersion body which is dispersed in anionic dispersing agent to be contained in an image forming layer.

However, in some techniques of the description in the patent documents described above, improvement on the printing durability is acknowledged, but on-board developability is not sufficient. Accordingly, with respect to the thermal fusion-type lithographic printing plate precursor, excellent on-board developability and sufficient printing durability are required.

### SUMMARY OF THE INVENTION

An object of the invention is to provide a thermal fusion-type lithographic printing plate precursor having extremely excellent on-board developability while maintaining printing durability. Another object of the invention is to provide a thermal fusion-type lithographic printing plate precursor having excellent preservation stability.

The objects of the invention are achieved by lithographic printing plate precursors below and a method for producing the same.
(1) A lithographic printing plate precursor including, on a support: an image recording layer containing (A) a thermoplastic fine particle polymer; (B) an infrared ray absorption agent; and (C) a polyglycerol compound, in which the polyglycerol compound is a compound having three or more structural units selected from structural units expressed by General Formulae (1) and (2) below,

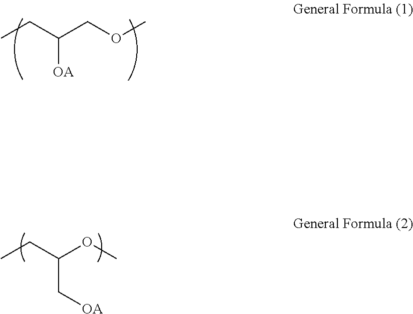

where, in General Formulae (1) and (2), A represents a hydrogen atom, an alkyl group having 1 to 4 carbon atoms, or an alkyl carbonyl group having 2 to 5 carbon atoms.
(2) The lithographic printing plate precursor according to (1), in which A in the structural units expressed by General Formulae (1) and (2) is a hydrogen atom.
(3) The lithographic printing plate precursor according to (1) or (2), in which the image recording layer contains a surfactant having a polyoxyalkylene group or a hydroxy group.
(4) The lithographic printing plate precursor according to (3), in which the surfactant having the polyoxyalkylene group or the hydroxy group is an anionic surfactant or a nonionic surfactant that has a polyoxyalkylene group or a hydroxy group.
(5) The lithographic printing plate precursor according to (4), in which the anionic surfactant or the nonionic surfactant having the polyoxyalkylene group or the hydroxy group is an anionic surfactant or a nonionic surfactant that has a polyoxyalkylene group.
(6) The lithographic printing plate precursor according to (5), in which the anionic surfactant or the nonionic surfactant having the polyoxyalkylene group is an anionic surfactant or a nonionic surfactant which has a polyoxyethylene group.
(7) A method for producing a plate including: image-exposing the lithographic printing plate precursor according to any one of (1) to (6), with an infrared ray laser; and removing an unexposed portion of the image recording layer by using at least one of printing ink and dampening water on a printing machine.

According to the invention, it is possible to obtain a thermal fusion-type lithographic printing plate precursor having extremely excellent on-board developability while maintaining printing durability. Also, it is possible to obtain a thermal fusion-type lithographic printing plate precursor having excellent preservation stability.

### DESCRIPTION OF THE PREFERRED EMBODIMENTS

Hereinafter, the invention is described in detail. In this specification, “(meth)acrylate” means at least one of acrylate and methacrylate. In the same manner, a “(meth)acryloyl group”, a “(meth)acrylic acid”, and a “(meth)acrylic resin” means “at least one of an acryloyl group and a methacryloyl group, at least one of an acrylic acid and a methacrylic acid, and at least one of an acrylic resin and a methacrylic resin”, respectively.

[Lithographic Printing Plate Precursor]

A lithographic printing plate precursor includes, on a support, an image recording layer containing (A) a thermoplastic fine particle polymer, (B) an infrared ray absorption agent, and (C) a polyglycerol compound, and the polyglycerol compound is a compound having three or more structural units selected from structural units expressed by General Formulae (1) and (2) above. With the lithographic printing plate precursor of the invention, it is possible to manufacture a lithographic printing plate by on-board development on the printing machine after image exposure.

Hereinafter, the lithographic printing plate precursor according to the invention is described in detail.

[Image Recording Layer]

The image recording layer in the lithographic printing plate precursor according to the invention contains (A) a thermoplastic fine particle polymer, (B) an infrared ray absorption agent, and (C) a polyglycerol compound. Components contained in the image recording layer are described below.

[Thermoplastic Fine Particle Polymer]

With respect to the thermoplastic fine particle polymer contained in the image recording layer of the lithographic printing plate precursor according to the invention, a glass transition temperature (Tg) is preferably 60° C. to 250° C. Tg of the thermoplastic fine particle polymer is more preferably 70° C. to 140° C. and still more preferably 80° C. to 120° C.

Examples of the thermoplastic fine particle polymer having Tg of 60° C. or greater suitably include thermoplastic fine particle polymers disclosed in Research Disclosure No. 33303 of January 1992, JP1997-123387A (JP-H9-123387A), JP1997-131850A (JP-H9-131850A), JP1997-171249A (JP-H9-171249A), JP1997-171250A (JP-H9-171250A) and EP931647B.

Specific examples thereof include a homopolymer or a copolymer constituted with a monomer such as ethylene, styrene, vinyl chloride, methyl acrylate, ethyl acrylate, methyl methacrylate, ethyl methacrylate, vinylidene chloride, acrylonitrile, or vinyl carbazole, or a mixture thereof. A homopolymer or a copolymer constituted with styrene, acrylonitrile, or methyl (meth)acrylate or a mixture thereof is preferable, and a homopolymer or a copolymer constituted with styrene or acrylonitrile or a mixture thereof is more preferable.

An average particle diameter of the thermoplastic fine particle polymer is preferably 0.005 μm to 2.0 μm. If the average particle diameter is too great, the resolution is deteriorated, and if the average particle diameter is too small, temporal stability is deteriorated. This value is applied, even in the case of the average particle diameter, in which two or more thermoplastic fine particle polymers are mixed. The average particle diameter is more preferably 0.01 μm to 1.5 μm and particularly preferably 0.05 μm to 1.0 μm. Polydispersity in a case where two or more types of thermoplastic fine particle polymers are mixed is preferably 0.2 or greater. The average particle diameter and the polydispersity are calculated by laser light scattering.

Two or more types of the thermoplastic fine particle polymers may be used in a mixed manner. Specifically, at least two or more types of the thermoplastic fine particle polymers having different particle sizes may be used or at least two or more types of the thermoplastic fine particle polymers having different Tg may be used. If the two or more types are used in mixture, coating film curing properties of the image portion are further enhanced, and printing durability is further enhanced when a lithographic printing plate is formed.

For example, if thermoplastic fine particle polymers having the same particle size are used, a certain degree of a gap exists between the thermoplastic fine particle polymers, and thus even if the thermoplastic fine particle polymers are melted and solidified by image exposure, curability of the coating film may not become a desired value. In contrast, if the thermoplastic fine particle polymers having different particle sizes are used, a void volume between the thermoplastic fine particle polymers can be reduced, and as a result, coating film curability of the image portion after image exposure can be enhanced.

In addition, if thermoplastic fine particle polymers having the same Tg are used, when the temperature increase of the image recording layer by the image exposure is not sufficient, the thermoplastic fine particle polymer is not sufficiently melted and solidified, and curability of the coating film may not become a desired value. In contrast, if thermoplastic fine particle polymers having different Tg are used, even if temperature increase of the image recording layer due to the image exposure is not sufficient, the coating film curability of the image portion can be enhanced.

If two or more types of thermoplastic fine particle polymers having different Tg are used in a mixed manner, Tg of at least one type of thermoplastic fine particle polymers is preferably 60° C. or greater. At this point, the difference of Tg is preferably 10° C. or greater, and more preferably 20° C. or greater. In addition, a content of the thermoplastic fine particle polymer having Tg of 60° C. or greater is preferably 70% by mass or greater with respect to the total thermoplastic fine particle polymers.

The thermoplastic fine particle polymer may have a crosslinkable group. If the thermoplastic fine particle polymer having a crosslinkable group is used, a crosslinkable group is thermally reacted by heat generated in an image exposure portion and a cross link is formed between the polymers, the strength of the coating film in the image portion is enhanced, and thus printing durability becomes more excellent. A functional group that performs a reaction in which a chemical bond is formed may be used as a crosslinkable group, and examples thereof include an ethylenically unsaturated group that performs a polymerization reaction (for example, an acryloyl group, a methacryloyl group, a vinyl group, and an allyl group), a group having an isocyanate group that performs addition reaction or a block body thereof and an active hydrogen atom which is a reaction counterpart thereof (for example, an amino group, a hydroxy group, or a carboxyl group), an epoxy group that performs addition reaction in the same manner, and an amino group, a carboxyl group or a hydroxy group, which is a reaction counterpart thereof, a carboxyl group that performs condensation reaction and a hydroxy group or an amino group, and an acid anhydride that performs a ring-opening addition reaction and an amino group or a hydroxy group.

Specific examples of the thermoplastic fine particle polymer that has a crosslinkable group include polymers that have a crosslinkable group such as an acryloyl group, a methacryloyl group, a vinyl group, an allyl group, an epoxy group, an amino group, a hydroxy group, a carboxyl group, an isocyanate group, acid anhydride, and a group in which these are protected. The introduction of these crosslinkable groups to a polymer may be performed at the time of polymerization of the fine particle polymer or may be performed by using a high molecular reaction after the polymerization of the fine particle polymer.

When a crosslinkable group is introduced at the time of the polymerization of a fine particle polymer, emulsion polymerization or suspension polymerization of a monomer having a crosslinkable group is preferable. Specific examples of the monomer having the crosslinkable group include allyl methacrylate, allyl acrylate, vinyl methacrylate, vinyl acrylate, glycidyl methacrylate, glycidyl acrylate. 2-isocyanate ethyl methacrylate, or block isocyanate with alcohols thereof, 2-isocyanate ethyl acrylate or block isocyanate with alcohols thereof, 2-aminoethyl methacrylate, 2-aminoethyl acrylate, 2-hydroxyethyl methacrylate, 2-hydroxyethyl acrylate, an acrylic acid, a methacrylic acid, maleic anhydride, bifunctional acrylate, and bifunctional methacrylate.

An example of the high molecular reaction used when the introduction of a crosslinkable group is performed after the polymerization of the fine particle polymer includes a high molecular reaction disclosed in WO96/34316A.

The thermoplastic fine particle polymer may react between fine particle polymers with a crosslinkable group interposed therebetween, and may react with a high molecular compound or a low molecular compound which is added to an image recording layer.

The content of the thermoplastic fine particle polymer is preferably 50% by mass to 95% by mass, more preferably 60% by mass to 90% by mass, and particularly preferably 70% by mass to 85% by mass with respect to a solid content of the image recording layer.

[Infrared Ray Absorption Agent]

The infrared ray absorption agent included in the image recording layer of the lithographic printing plate precursor according to the invention is preferably a dye or a pigment having absorption maximum of 760 nm to 1200 nm. A dye is more preferable.

As the dye, commercially available dyes and well-known dyes disclosed in documents (for example, “a catalog of dyes” Society of Synthetic Organic Chemistry of Japan, 1970, “Near Infrared Absorbent Coloring Matter” pages 45 to 51 of “Chemical Industry” May 1986, Second edition of Column 2.3 of “1990's development and market trend of functional coloring matter” (CMC Publishing Co., Ltd., published in 1990)) or patents can be used. Specifically, an infrared ray absorbing dye such as an azo dye, a metal complex salt azo dye, a pyrazolone azo dye, an anthraquinone dye, a phthalocyanine dye, a carbonium dye, a quinonimine dye, a polymethine dye, and a cyanine dye is preferable.

For example, cyanine dyes disclosed in JP1983-125246A (JP-S58-125246A), JP1984-84356A (JP-S59-84356A), JP1985-78787A (JP-S60-78787A), JP1983-173696A (JP-S58-173696A), JP1983-194595A (JP-S58-194595A), JP1984-216146A (JP-S59-216146A), GB434875B and U.S. Pat. No. 4,973,572A, cyanine dyes and azomethine dyes disclosed in U.S. Pat. No. 4,756,993A, methine dyes disclosed in JP1983-181690A (JP-S58-181690A), naphthoquinone dyes disclosed in JP1983-112793A (JP-S58-112793A), JP1983-224793A (JP-S58-224793A), JP1984-48187A (JP-S59-48187A), JP1984-73996A (JP-S59-73996A), JP1985-52940A (JP-S60-52940A), and JP1985-63744A (JP-S60-63744A), squalium dyes disclosed in JP1983-112792A (JP-S58-112792A), phthalocyanine compounds disclosed in JP1999-235883A (JP-H11-235883A), or various dyes disclosed in JP1998-268512A (JP-H10-268512A).

In addition, as the dye, near infrared absorbing sensitizers disclosed in U.S. Pat. No. 5,156,938A are also suitably used, and arylbenzo(thio)pyrylium salts disclosed in U.S. Pat. No. 3,881,924A, trimethine thiapyrylium salt disclosed in JP1982-142645A (JP-S57-142645A), pyrylium-based compounds disclosed in JP1983-181051A (JP-S58-181051A), JP1983-220143A (JP-S58-220143A). JP1984-41363A (JP-S59-41363A), JP1984-84248A (JP-S59-84248A), JP1984-84249A (JP-S59-84249A), JP1984-146063A (JP-S59-146063A), JP1984-146061A (JP-S59-146061A), JP1993-13514A (JP-H5-13514B), and JP1993-19702A (JP-H5-19702B), pentamethine thiopyrylium salts disclosed in U.S. Pat. No. 4,283,475A, and EPOLITE III-178, EPOLITE III-130, and EPOLITE III-125 manufactured by Epolin Inc. are preferably used.

Among these, particularly preferable dyes to be added to the image recording layer are an infrared ray absorbing dye having a water-soluble group.

Hereinafter, specific examples of the infrared ray absorbing dye are described below, but the invention is not limited thereto.

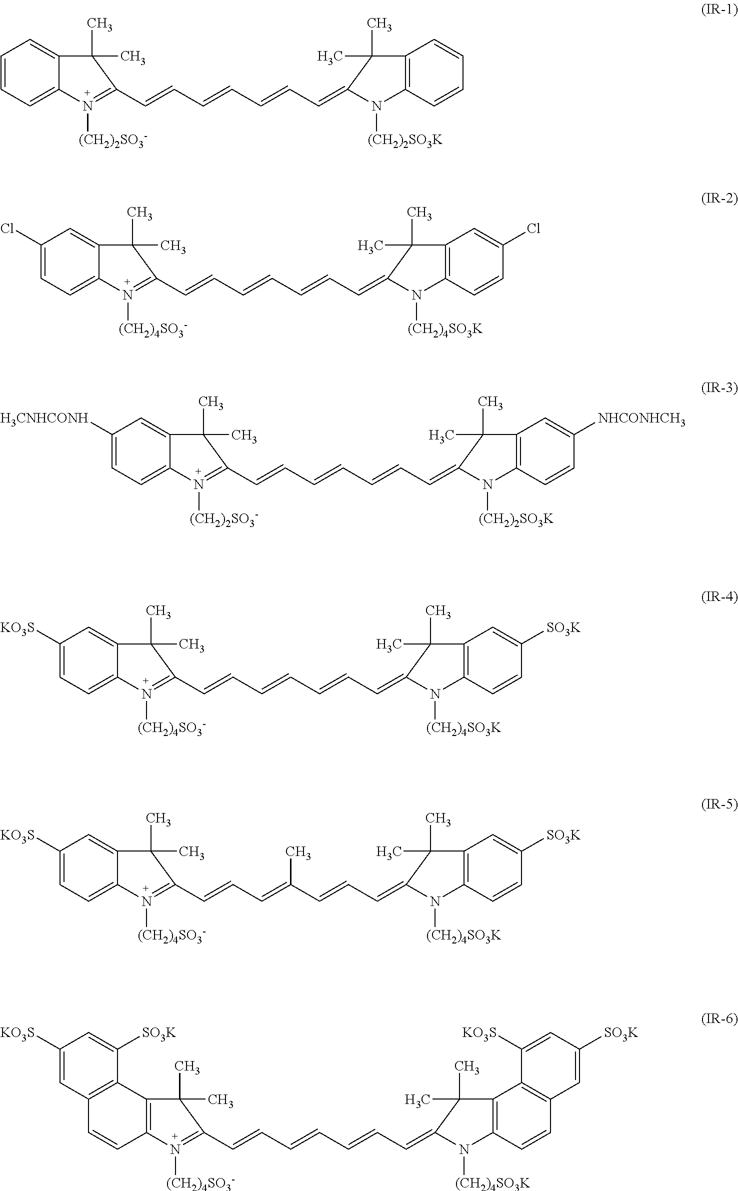

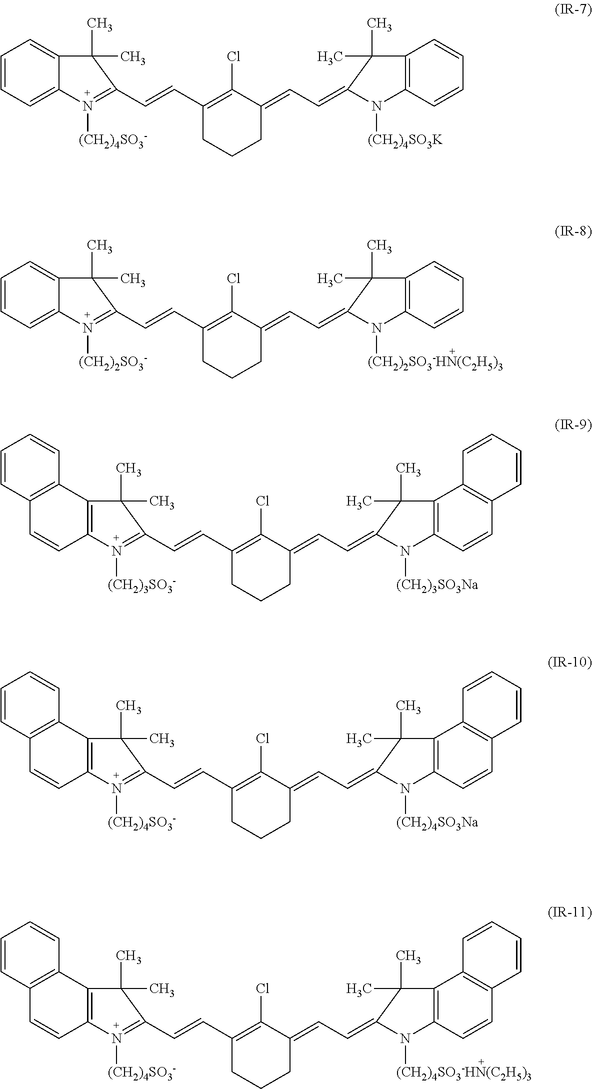

As the pigment, commercially available pigments, a catalog of Color Index (C.I.), and pigments disclosed in “Catalog of Latest Pigments” (edited by the Pigment Technology Society of Japan, published in 1977), “New Pigment Application Technology” (edited by CMC publishing Co., Ltd., published in 1986), and “Printing Ink Technology” (edited by CMC publishing Co., Ltd., published in 1984) can be used.

Examples of types of the pigments include black pigments, brown pigments, red pigments, purple pigments, blue pigments, green pigments, fluorescent pigments, metal powder pigments, and also polymer-bonded coloring matters. Specifically, insoluble azo pigments, azo lake pigments, condensed azo pigments, chelate azo pigments, phthalocyanine-based pigments, anthraquinone-based pigments, perylene and perinone-based pigments, thioindigo-based pigments, quinacridone-based pigments, dioxazine-based pigments, isoindolinone-based pigments, quinophthalone-based pigments, dyed lake pigments, azine pigments, nitroso pigments, nitro pigments, natural pigments, fluorescent pigments, inorganic pigments, and carbon black can be used.

The pigment may not be subjected to the surface treatment to be used, and may be subjected to the surface treatment to be used. The method of the surface treatment may include a method of coating surfaces of a hydrophilic resin or a lipophilic resin, a method of causing a surfactant to be attached, a method of bonding a reactive substance (for example, silica sol, alumina sol, a silane coupling agent, an epoxy compound, and an isocyanate compound) to a surface of a pigment, and the like. The surface treatment methods described above are disclosed in “Characteristics And Applications Of Metal Soap” (Saiwai Shobo), “Printing Ink Technology” (edited by CMC publishing Co., Ltd., published in 1984), and “Latest Pigment Application Technology” (edited by CMC publishing Co., Ltd., published in 1986).

The particle diameter of the pigment is preferably 0.01 μm to 1 μm and more preferably 0.01 μm to 0.5 μm. As the method of dispersing a pigment, a well-known dispersing technique used in ink production, toner production, or the like can be used. Details thereof are described in “Latest Pigment Application Technology” (edited by CMC publishing Co., Ltd., published in 1986).

The content of the infrared ray absorption agent is preferably 0.1% by mass to 30% by mass, more preferably 0.25% by mass to 25% by mass, and particularly preferably 0.5% by mass to 20% by mass with respect to a solid content of the image recording layer. In this scope, satisfactory sensitivity can be obtained without deteriorating film strength of the image recording layer.

[Polyglycerol Compound]

The polyglycerol compound included in the image recording layer of the lithographic printing plate precursor according to the invention includes three or more structural units selected from structural units expressed by General Formulae (1) and (2) below.

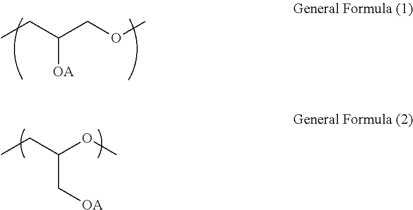

In General Formulae (1) and (2), A represents a hydrogen atom, an alkyl group having 1 to 4 carbon atoms, or an alkyl carbonyl group having 2 to 5 carbon atoms.

As A in General Formulae (1) and (2), a hydrogen atom, a methyl group, an ethyl group, a methyl carbonyl group, or an ethyl carbonyl group is preferable, and a hydrogen atom is particularly preferable.

The number of structural units expressed by General Formulae (1) and (2) in the polyglycerol compound is preferably 3 to 500, more preferably 3 to 200, still more preferably 3 to 100, and particularly preferably 6 to 60.

The hydroxyl value of the polyglycerol compound is preferably 670 to 1100 and more preferably 770 to 1100. The hydroxyl value is the mg number of potassium hydroxide required for neutralizing an acetic acid bonded to a hydroxy group when 1 g of the polyglycerol compound is acetylated. The mg number of potassium hydroxide is calculated in conformity with “Standard Methods for the Analysis of Fats, Oils and Related Materials (I) regulated by Japan Oil Chemists' Society”, in 2013.

The polyglycerol compound may be a straight chain compound or may be a branched compound. The branched compound has a structure, for example, in which A in General Formula (1) or (2) becomes a single bond, and in which a structural unit expressed by General Formula (1) or (2) is bonded to this, so as to form a branched chain. In this case, the polyglycerol compound includes a structural unit (here, O* represents a position at which a branched chain is bonded) expressed by (a) or (b) below. In addition, for the reason of synthesis, the polyglycerol compound may include a cyclic structural unit including a hydrogen atom, for example, a structural unit expressed by (c) below.

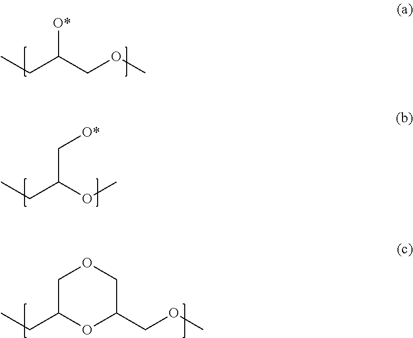

The terminal structure of the polyglycerol compound is any one of a hydroxy group, an alkoxy group having 1 to 4 carbon atoms, and an alkylcarbonyloxy group having 2 to 5 carbon atoms. It is preferable that all terminal structures are hydroxy groups.

The polyglycerol compound is substantially formed of only structural units expressed by General Formulae (1) and (2), even if the polyglycerol compound has plural hydroxy groups and a portion of the hydroxy group is substituted with an alkyl group having 4 or less carbon atoms or an alkyl carbonyl group having 5 or less carbon atoms, hydrophilicity of the polyglycerol compound is extremely high, and surfactant activity is not substantially exhibited. Therefore, at the time of on-board development, dampening water does not penetrate the exposed portion (image portion) of the image recording layer such that hydrophobicity of the image portion or strength of a coating film is not deteriorated, and thus ink storing properties of the image portion or printing durability can be satisfactorily maintained.

The polyglycerol compound is synthesized by a well-known method. For example, the polyglycerol compound is synthesized by referring to disclosures in polyglycerol ester (edited by Sakamoto Yakuhin kogyo Co., Ltd., 1994), Eur. J. Org. Chem., 2001, 875-896, and the like.

In addition, commercially available products can be used, and examples thereof include POLYGLYCERIN #310, POLYGLYCERIN #500, POLYGLYCERIN #750 (above, manufactured by Sakamoto Yakuhin kogyo Co., Ltd.), POLYGLYCERIN (manufactured by Yokkaichi Chemical Company Limited.), POLYGLYCERIN PGL 06, POLYGLYCERIN PGL 10, and POLYGLYCERIN PGL X (above manufactured by Daicel Corporation).

The content of the polyglycerol compound is preferably 0.1% by mass to 30% by mass and more preferably 0.5% by mass to 20% by mass with respect to the solid content of the image recording layer.

Hereinafter, specific examples of polyglycerol compounds used in the invention are provided, but the invention is not limited thereto.

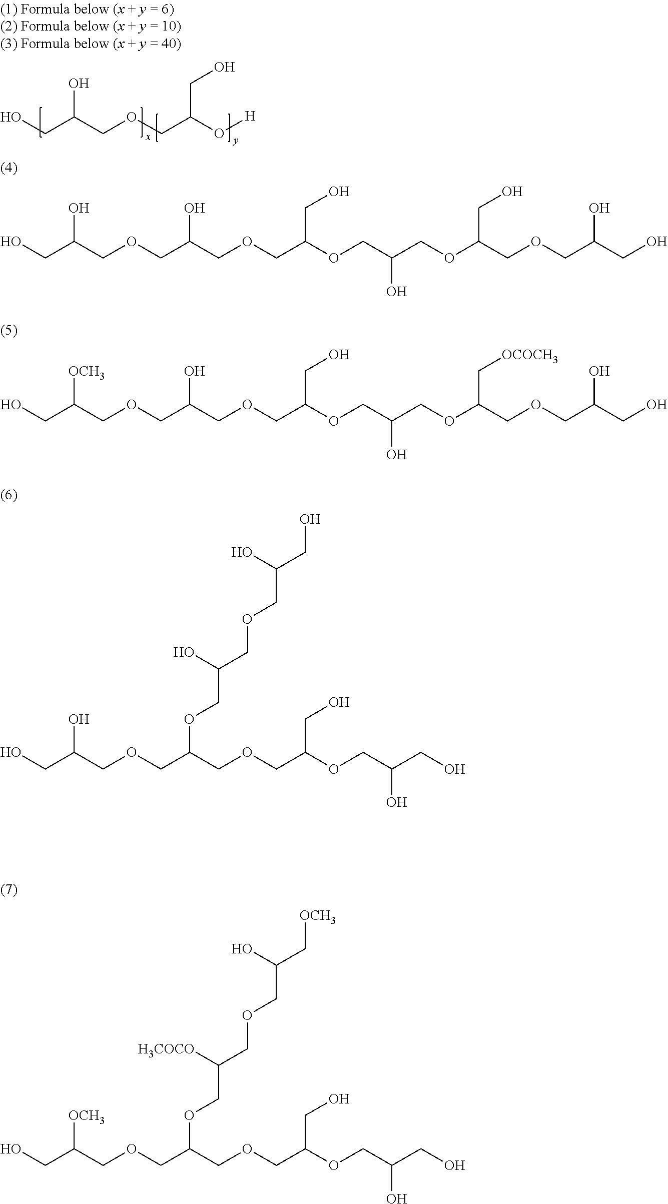

The lithographic printing plate precursor according to the invention has excellent on-board developability by containing the polyglycerol compound in the image recording layer. If the image recording layer further contains a surfactant having a polyoxyalkylene group or a hydroxy group, the excellent on-board developability is satisfactorily maintained even if the lithographic printing plate precursor is preserved over time. That is, the lithographic printing plate precursor according to the invention which has an image recording layer containing a surfactant having a polyoxyalkylene chain or a hydroxy group together with a polyglycerol compound exhibits excellent on-board developability even in the case of being preserved in a hot condition or a hot and humid condition.

[Surfactant Having Polyoxyalkylene Group or Hydroxy Group]

As the surfactant having a polyoxyalkylene group (hereinafter, referred to as “POA group”) or a hydroxy group which is contained in the image recording layer according to the invention, a surfactant having a POA group or a hydroxy group can be appropriately used, but an anionic surfactant or a nonionic surfactant is preferable. Among an anionic surfactant or a nonionic surfactant surfactant having a POA group or a hydroxy group, an anionic surfactant or a nonionic surfactant having a POA group is preferable.

As the POA group, a polyoxyethylene group, a polyoxypropylene group, a polyoxybutylene group, or the like is preferable, and a polyoxyethylene group is particularly preferable.

It is general that an average degree of polymerization of an oxyalkylene group is suitably 2 to 50 and preferably 2 to 20.

It is general that the number of hydroxy groups is suitably 1 to 10 and preferably 2 to 8. However, a terminal hydroxy group in an oxyalkylene group is not included in the number of the hydroxy groups.

(Anionic Surfactant Having POA Group or Hydroxy Group)

The anionic surfactant having a POA group is not particularly limited, and examples thereof include polyoxyalkylene alkyl ether carboxylic acid salts, polyoxyalkylene alkylsulfosuccinic acid salts, polyoxyalkylene alkyl ether sulfuric acid ester salts, alkyl phenoxy polyoxyalkylene propylsulfonic acid salts, polyoxyalkylene alkyl sulfophenyl ethers, polyoxyalkylene aryl ether sulfuric acid ester salts, polyoxyalkylene polycylic phenyl ether sulfuric acid ester salts, polyoxyalkylene styryl phenyl ether sulfuric acid ester salts, polyoxyalkylene alkyl ether phosphoric acid ester salts, polyoxyalkylene alkyl phenyl ether phosphoric acid ester salts, and polyoxyalkylene perfluoroalkyl ether phosphoric acid ester salts.

The anionic surfactant having a hydroxy group is not particularly limited, and examples thereof include hydroxycarboxylic acid salts, hydroxyalkyl ether carboxylic acid salts, hydroxyalkanesulfonic acid salts, fatty acid monoglyceride sulfuric acid ester salts, and fatty acid monoglyceride phosphoric acid ester salts.

The anionic surfactant having a POA group or a hydroxy group is preferably a compound expressed by General Formula (S1) below.

R₁—Y₁—X₁ General Formula (S1)

In General Formula (S1), R₁ represents an alkyl group or an aryl group. Y₁ represents a single bond, an alkylene group, a polyoxyalkylene group, an arylene group, —O—, —NH—, a carbonyl group, or a bivalent linking group obtained by combining two or more of these groups. X₁ represents an acid group or salts thereof. However, at least one of R₁ and Y₁ includes at least one of a polyoxyalkylene group or a hydroxy group.

The alkyl group represented by R₁ is preferably a straight chain, branched, or cyclic alkyl group having 6 to 30 carbon atoms. Specific examples of the alkyl group include a hexyl group, a heptyl group, an octyl group, a nonyl group, a decyl group, an isohexyl group, a 2-ethylhexyl group, a 2-methylhexyl group, a cyclohexyl group, a 1-adamantyl group, a 2-norbornyl group, a lauryl group, and a stearyl group.

The aryl group represented by R₁ is preferably an aryl group having 6 to 30 carbon atoms and more preferably an aryl group having 6 to 10 carbon atoms. Specific examples of the aryl group include a phenyl group, a naphtyl group, an indenyl group, and an anthranil group.

The alkylene group or the arylene group represented by R₁ may have a substituent.

The alkylene group represented by Y₁ is preferably an alkylene group having 18 or less carbon atoms and more preferably an alkylene group having 6 or less carbon atoms. Specific examples of the alkylene group include a methylene group, an ethylene group, a propylene group, and a butylene group.

The polyoxyalkylene group represented by Y₁ is preferably a polyoxyethylene group or a polyoxypropylene group and more preferably a polyoxyethylene group.

The arylene group represented by Y₁ is preferably an arylene group having 6 to 30 carbon atoms and more preferably an arylene group having 6 to 10 carbon atoms.

The alkylene group or the arylene group represented by Y₁ may have a substituent.

Y₁ is preferably a single bond, a polyoxyalkylene group, an alkylene group, —O—, a carbonyl group, or a bivalent linking group obtained by combining two or more of these groups. Examples thereof include —(OCH₂CH₂)ₙ—O— (n represents an integer of 2 to 30), and —(OCH₂CH₂)ₙ—(CH₂)ₘ— (n represents an integer of 2 to 30, and m represents an integer of 1 to 18).

Examples of the substituent that may be included in R₁ or Y₁ include a halogen atom (for example, a fluorine atom, a chlorine atom, a bromine atom, and an iodine atom) or a univalent non-metallic atomic group. Examples of the univalent non-metallic atomic group include an alkyl group (a straight chain, branched, cyclic substituted or unsubstituted alkyl group having 1 to 30 carbon atoms is preferable, an alkyl group having 1 to 20 carbon atoms is more preferable, and examples thereof include methyl, ethyl, n-propyl, isopropyl, t-butyl, n-octyl, eicosyl, 2-chloroethyl, 2-cyanoethyl, 2-ethylhexyl, cyclohexyl, cyclopentyl, and 4-n-dodecylcyclohexyl), an aryl group (a substituted or unsubstituted aryl group having 6 to 30 carbon atoms is preferable, a substituted or unsubstituted aryl group having 6 to 20 carbon atoms is more preferable, and examples thereof include phenyl, p-tolyl, naphtyl, m-chlorophenyl, and o-hexadecanoyl aminophenyl), a hydroxy group, a carboxyl group, or salts thereof, an alkoxy group (a substituted or unsubstituted alkoxy group having 1 to 30 carbon atoms is preferable, and a substituted or unsubstituted alkoxy group having 1 to 20 carbon atoms is more preferable, and examples thereof include methoxy, ethoxy, isopropoxy, t-butoxy, n-octyloxy, and 2-methoxyethoxy), an aryloxy group (a substituted or unsubstituted aryloxy group having 6 to 30 carbon atoms is preferable, a substituted or unsubstituted aryloxy group having 6 to 20 carbon atoms is more preferable, and examples thereof include phenoxy, 2-methylphenoxy, 4-t-butylphenoxy, 3-nitrophenoxy, 2-tetradecanoyl aminophenoxy), an acyloxy group (a formyloxy group, a substituted or unsubstituted alkylcarbonyloxy group having 2 to 30 carbon atoms, and a substituted or unsubstituted arylcarbonyloxy group having 6 to 30 carbon atoms are preferable, and examples thereof include formyloxy, acetyloxy, pivaloyloxy, stearoyloxy, benzoyloxy, and p-methoxyphenylcarbonyloxy), a sulfo group or salts thereof, an aryloxycarbonyl group (a substituted or unsubstituted aryloxycarbonyl group having 7 to 30 carbon atoms is preferable, and examples thereof include phenoxycarbonyl, o-chlorophenoxycarbonyl, m-nitrophenoxycarbonyl, and p-t-butylphenoxycarbonyl), an alkoxycarbonyl group (a substituted or unsubstituted alkoxycarbonyl group having 2 to 30 carbon atoms is preferable, and examples thereof include methoxycarbonyl, ethoxycarbonyl, t-butoxycarbonyl, and n-octadecyloxycarbonyl), a polyoxyalkylene group (expressed by —(OCₙH₂ₙ)ₘ—OR, where n preferably represents an integer of 2 to 4, R represents a hydrogen atom or an alkyl group, and a hydrogen atom is preferable, m preferably represents an integer of 2 to 30, an integer of 2 to 20 is more preferable, and examples thereof include a polyoxyethylene group —(OCH₂CH₂)ₘ—OH, and a polyoxypropylene group —(OCH₂CH(CH₃)ₘ—OH)).

Among the substituents, a hydrogen atom may be removed from a substituent having a hydrogen atom, and this substituent may be further substituted with the substituent described above.

Among the substituents, an alkyl group, an alkoxy group, an aryloxy group, a hydroxy group, a sulfo group or a salt thereof, or a polyoxyalkylene group is preferable.

X₁ preferably represents —SO₃H, —COOH, —PO₃H₂, or a salt thereof. Cation groups that form the acid group and the salt described above are not particularly limited, and all cation groups can be used. Among the cation groups, an inorganic cation group such as a lithium cation, a sodium cation, and a potassium cation and an organic cation group such as a quarternary ammonium group and a quarternary phosphonium group are preferable.

(Nonionic Surfactant Having POA Group or Hydroxy Group)

The nonionic surfactant having POA group is not particularly limited, and examples thereof include polyoxyalkylene alkyl ethers, polyoxyalkylene glyceryl ether fatty acid ester, polyoxyalkylene alkyl phenyl ethers, polyoxyalkylene alkyl naphthyl ethers, polyoxyethylene polyoxypropylene glycols, polyoxyalkylene fatty acid esters, polyoxyalkylene sorbitan fatty acid esters, fatty acid polyoxyalkylene sorbitols, polyoxyalkylene hydrogenated castor oil, polyether-modified silicone oils, glycerin fatty acid esters, sorbitan fatty acid esters, sucrose fatty acid esters, alkyl glyceryl ether, alkyl glycosides, and polyoxyalkylene perfluoroalkyl ether.

The nonionic surfactant having a hydroxy group is not particularly limited, and examples thereof include glycerin fatty acid esters, sorbitan fatty acid esters, sucrose fatty acid esters, alkyl glyceryl ether, polyoxyalkylene sorbitan fatty acid esters, fatty acid alkanolamides, alkyl glycosides, fluorine telomer alcohols, and polyether-modified silicone oils.

The nonionic surfactant having a POA group or a hydroxy group is preferably a compound expressed by General Formula (S2) below.

R₂₁—Y₂—R₂₂ General Formula (S2)

In General Formula (S2), R₂₁ represents an alkyl group, an aryl group or a cyclic ether group. Y₂ represents a single bond, an alkylene group, a polyoxyalkylene group, an arylene group, —O—, —NH—, a carbonyl group, or a bivalent linking group obtained by combining two or more of these groups. R₂₂ represents a hydrogen atom or a hydroxy group. However, the surfactant expressed by General Formula (S2) has at least one of a polyoxyalkylene group or a hydroxy group.

The alkyl group and the aryl group represented by R₂₁ have the same meaning as the alkyl group and the aryl group represented by R₁ in General Formula (S1), and also preferable scopes thereof are the same. The alkylene group or the arylene group represented by R₂₁ may have a substituent.

The cyclic ether group represented by R₂₁ is preferably a cyclic ether group having 2 to 6 carbon atoms, and more preferably a cyclic ether group having 5 to 6 carbon atoms. Specific examples of the cyclic ether group include an oxetanyl group, a tetrahydrofuranyl group, and a tetrahydropyranyl group.

The alkylene group represented by Y₂ is preferably an alkylene group having 18 or less carbon atoms and more preferably an alkylene group having 6 or less carbon atoms. Specific examples of the alkylene group include a methylene group, an ethylene group, a propylene group, and a butylene group.

The polyoxyalkylene group represented by Y₂ is expressed by —(OCₙH₂ₙ)ₘ— (n preferably represents an integer of 2 to 4 and more preferably represents an integer of 2 to 3, m preferably represents an integer of 2 to 30 and more preferably represents an integer of 2 to 20, and CₙH₂ₙ represents a straight chain or branched alkylene group). As the polyoxyalkylene group, a polyoxyethylene group expressed by —(OCH₂CH₂)ₘ— or a polyoxypropylene group expressed by —(OCH₂CH(CH₃))ₘ— is preferable, and a polyoxyethylene group is more preferable.

As the an arylene group represented by Y₂, an arylene group having 6 to 30 carbon atoms is preferable, and an arylene group having 6 to 10 carbon atoms is more preferable.

The alkylene group or the arylene group represented by Y₂ may have a substituent.

Y₂ represents preferably a polyoxyalkylene group, an alkylene group, —O—, —NH—, a carbonyl group, or a bivalent linking group obtained by combining two or more of these groups. Examples thereof include —(OCH₂CH₂)ₙ—O— (n represents an integer of 2 to 30), —(OCH₂CH₂)ₙ—(CH₂)ₘ— (n represents an integer of 2 to 30, and m represents an integer of 1 to 18), —C(O)—O—(CH₂)n- (n represents an integer of 1 to 6), and —C(O)—NH—(CH₂)n- (n represents an integer of 1 to 6).

The substituent that may be included in R₂₁ or Y₂ has the same meaning as the substituent that may be included in R₁ or Y₁ in General Formula (S1), except for a sulfo group or a salt thereof, and preferable scopes thereof are the same.

The content of the surfactant having a POA group or a hydroxy group is preferably 0.05% by mass to 15% by mass and more preferably 0.1% by mass to 10% by mass with respect to a total content of the image recording layer.

Hereinafter, specific examples of the surfactants included in a POA group or a hydroxy group, which are used in the invention are provided below, but the invention is not limited thereto. A surfactant A-12 described below can be obtained from Du Pont Kabushiki Kaisha in a product name of ZONYL FSP. In addition, a surfactant N-11 described below can be obtained from Du Pont Kabushiki Kaisha in a product name of ZONYL FSO 100.

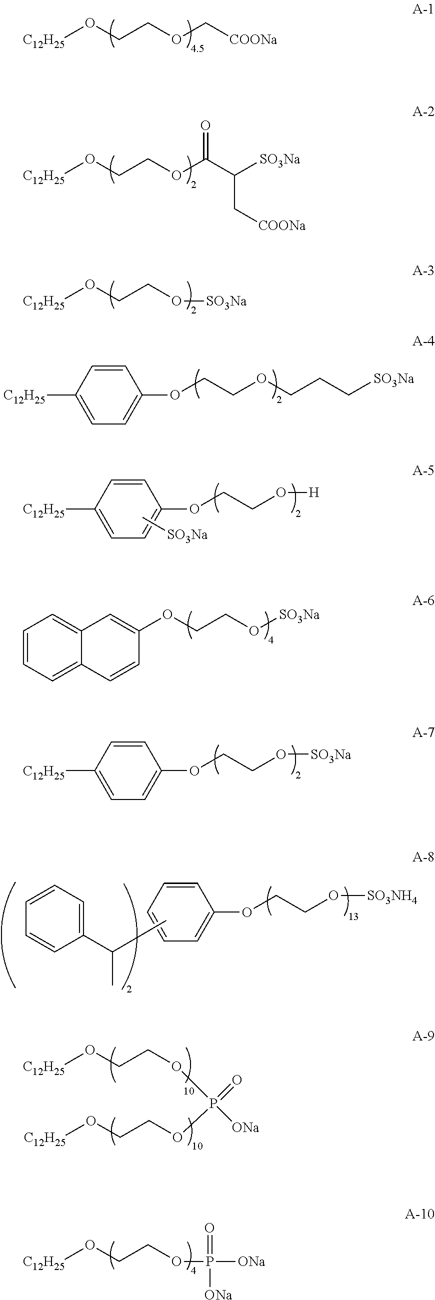

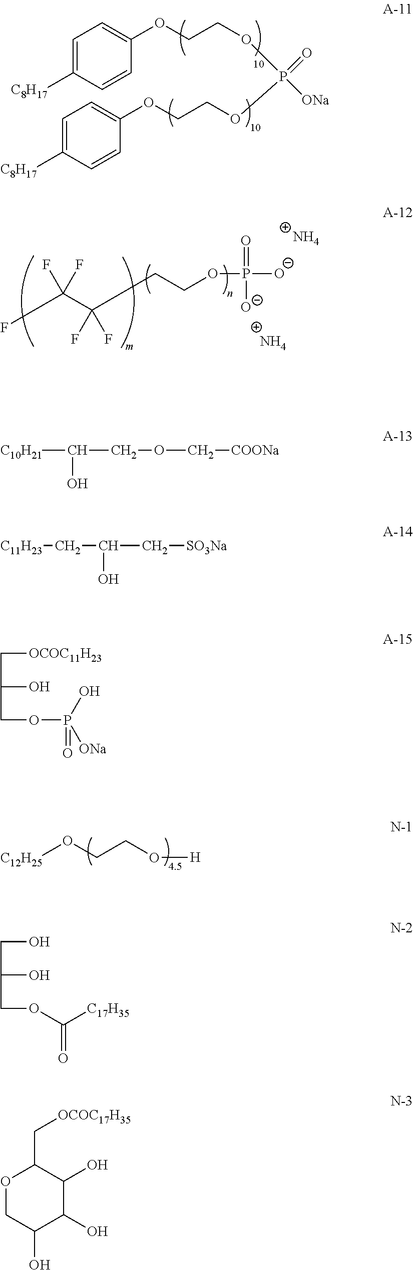

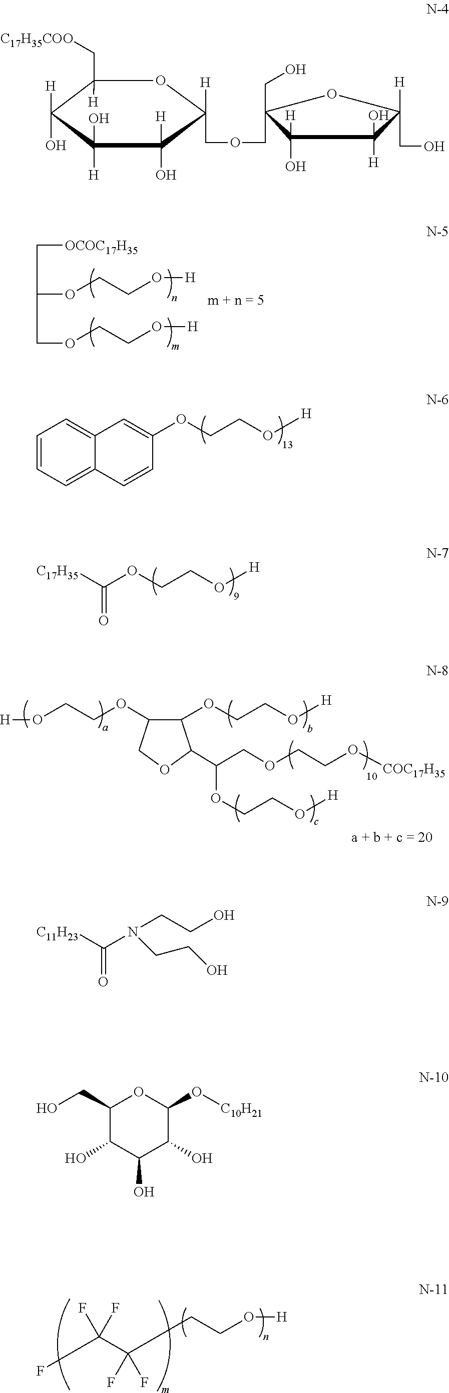

For the purpose of securing evenness of coating of the image recording layer, the image recording layer according to the invention may contain an anionic surfactant not having a polyoxyalkylene group and a hydroxy group.

The corresponding anionic surfactant is not particularly limited, as long as the anionic surfactant achieves the purpose described above. Among them, an alkyl benzene sulfonic acid or a salt thereof, an alkyl naphthalene sulfonic acid or a salt thereof, a (di)alkyldiphenyl ether (di)sulfonic acid or a salt thereof, and an alkyl sulfuric acid ester salt is preferable.

The addition amount of the anionic surfactant not having a polyoxyalkylene group and a hydroxy group is preferably 1% by mass to 50% by mass and more preferably 1% by mass to 30% by mass with respect to the surfactant having the polyoxyalkylene group or the hydroxy group.

Hereinafter, specific examples of the anionic surfactant not having a polyoxyalkylene group and a hydroxy group are provided, but the invention is not limited thereto.

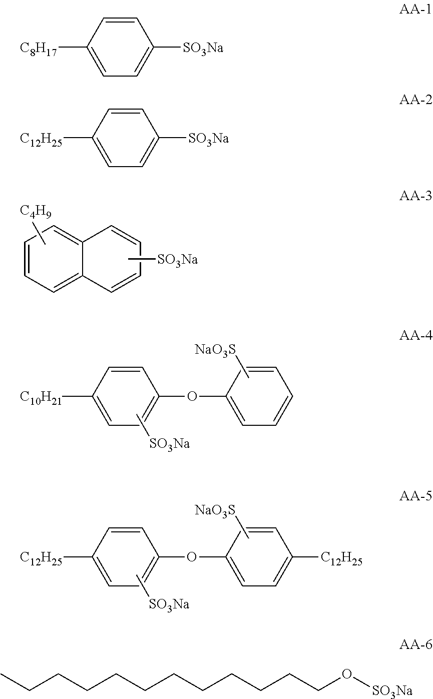

In addition, for the purpose of securing the evenness of coating of the image recording layer, a fluorine-based surfactant or a nonionic surfactant not having a polyoxyalkylene group and a hydroxy group may be used. For example, fluorine-based surfactants disclosed in JP1987-170950A (JP-S62-170950A) are preferably used.

The image recording layer according to the invention may contain a hydrophilic resin. As the hydrophilic resin, for example, a hydroxy group, a hydroxyethyl group, a hydroxypropyl group, an amino group, an aminoethyl group, an aminopropyl group, a carboxyl group, a carboxylate group, a sulfo group, a sulfonato group, and a phosphate group are preferable.

Specific examples of the hydrophilic resin include gum arabic, casein, gelatin, starch derivatives, carboxymethyl cellulose and a sodium salt thereof, cellulose acetate, sodium alginate, vinyl acetetate-maleic acid copolymers, styrene-maleic acid copolymers, polyacrylic acids and salts thereof, polymethacrylic acids and salts thereof, a homopolymer and a copolymer of hydroxyethyl methacrylate, a homopolymer and a copolymer of hydroxyethyl acrylate, a homopolymer and a copolymer of hydroxypropyl methacrylate, a homopolymer and a copolymer of hydroxypropyl acrylate, a homopolymer and a copolymer of hydroxybutyl methacrylate, a homopolymer and a copolymer of hydroxybutyl acrylate, polyethylene glycols, hydroxypropylenepolymers, polyvinyl alcohols, polyvinyl acetate having a degree of hydrolysis of at least 60% and preferably 80% of a degree of hydrolysis, polyvinyl formal, polyvinyl butyral, polyvinyl pyrrolidone, a homopolymer and a copolymer of acrylamide, a homopolymer and a copolymer of methacrylamide, and a homopolymer and a copolymer of N-methylolacrylamide.

The molecular weight of the hydrophilic resin is preferably 2,000 or greater. If the molecular weight is less than 2,000, sufficient coating film strength or printing durability is not obtained, and thus the molecular weight of less than 2,000 is not preferable.

The content of the hydrophilic resin is preferably 0.5% by mass to 50% by mass and more preferably 1% by mass to 30% by mass with respect to a solid content of the image recording layer.

Inorganic fine particles may be added to the image recording layer according to the invention. Suitable examples of the inorganic fine particle include silica, alumina, magnesium oxide, titanium oxide, magnesium carbonate, calcium alginate, or mixtures thereof. The inorganic fine particle can be used for strengthening a coating film.

The average particle diameter of the inorganic fine particles is preferably 5 nm to 10 μm and more preferably 10 nm to 1 μm. In this scope, inorganic fine particles are stably dispersed with a thermoplastic fine particle polymer and the film strength of the image recording layer is sufficiently maintained, and thus the non-image portion in which a printing stain hardly occurs and hydrophilicity is excellent can be formed.

The inorganic fine particles can be easily obtained as commercially available products of colloidal silica dispersion and the like.

The content of the inorganic fine particles is preferably 1.0% by mass to 70% by mass and more preferably 5.0% by mass to 50% by mass with respect to a solid content of the image recording layer.

If necessary, a plasticizer can be added to the image recording layer according to the invention, in order to provide flexibility of the coating film. Examples of the plasticizer include polyethylene glycol, tributyl citricate, diethyl phthalate, dibutyl phthalate, dihexyl phthalate, dioctyl phthalate, tricresyl phosphate, tributyl phosphate, trioctyl phosphate, and tetrahydrofurfuryl oleate.

The content of the plasticizer is preferably 0.1% to 50% by mass and more preferably 1% by mass to 30% by mass with respect to a solid content of the image recording layer.

With respect to the image recording layer according to the invention, if the fine particle polymer having a thermal reactive functional group (crosslinkable group) is used, a compound that initiates or promotes reaction of a thermal reactive functional group (crosslinkable group) can be added, if necessary. Examples of the compound that initiates or promotes reaction of a thermal reactive functional group include a compound that generates a radical or a cation due to heat, for example, lophine dimer, a trihalomethyl compound, peroxide, an azo compound, onium salts including diazonium salts and diphenyliodonium salts, acylphosphine, and imido sulfonate. The addition amount of these compounds is preferably 1% by mass to 20% by mass and more preferably 1% by mass to 10% by mass with respect to a solid content of the image recording layer. In this scope, it is possible to obtain satisfactory reaction initiation or promotion effects without deteriorating on-board developability.

[Forming of Image Recording Layer]

The image recording layer according to the invention is formed by dissolving or dispersing the respective components described above in a proper solvent, preparing a coating liquid, and coating a support. As the solvent, water or a mixed solvent of water and an organic solvent can be used, but the mixed use of water and an organic solvent is preferable in order to make a surface shape after coating satisfactory. The amount of the organic solvent is different according to the kind of the organic solvent, and thus may not be specified in an unconditional manner, but is preferably 5% by volume to 50% by volume with respect to the mixed solvent, generally. However, the organic solvent is required to be used in an amount in which a thermoplastic fine particle polymer does not aggregate. The solid content concentration of the coating liquid for the image recording layer is preferably 1% by mass to 50% by mass.

The organic solvent as the solvent of the coating liquid is preferably an organic solvent that is soluble to water. Specific examples thereof include an alcohol solvent such as methanol, ethanol, propanol, isopropanol, and 1-methoxy-2-propanol, a ketone solvent such as acetone and methyl ethyl ketone, a glycol ether solvent such as ethylene glycol dimethyl ether, γ-butyrolactone, N,N-dimethylformamide, N,N-dimethylacete amide, tetrahydrofuran, and dimethylsulfoxide. Particularly, a boiling point is 120° C. or less, and an organic solvent having solubility to water (dissolved amount with respect to 100 g of water) of 10 g or more is preferable, and an organic solvent having solubility of 20 g or more is more preferable.

As the coating method of the coating liquid for the image recording layer, various kinds of methods can be used. Examples thereof include bar coater coating, rotary coating, spray coating, curtain coating, dip coating, air knife coating, blade coating, and roll coating. The coating amount (solid content) of the image recording layer on a support obtained after coating and drying varies depending on the use, but, is preferably 0.5 g/m² to 5.0 g/m² and more preferably 0.5 g/m² to 2.0 g/m², generally.

[Support]

The support used in the lithographic printing plate precursor according to the invention is a substrate having a hydrophilic surface or a substrate provided with a hydrophilic surface by applying a hydrophilic layer. Specifically, paper, paper on which plastic (for example, polyethylene, polypropylene, and polystyrene) is laminated, a metal plate (for example, aluminum, zinc, and copper), a plastic film (for example, cellulose diacetate, cellulose triacetate, cellulose propionate, cellulose butyrate, cellulose acetate butyrate, cellulose nitrate, polyethylene terephthalate, polyethylene, polystyrene, polypropylene, polycarbonate, and polyvinylacetal), paper, or a plastic film on which the metal described above is laminated or vapor deposited, or a substrate obtained by coating the substrate described above with a hydrophilic layer. Examples of a preferable support include an aluminum plate and a polyester film coated with a hydrophilic layer.

The aluminum plate includes a pure aluminum plate and an alloy plate including aluminum as a main component and a small amount of a foreign element, and further may be a plate on which plastic is laminated on an aluminum or aluminum alloy thin film. Examples of the foreign element included in the aluminum alloy include silicon, iron, manganese, copper, magnesium, chromium, zinc, bismuth, nickel, and titanium. The content of the foreign element in the alloy is 10% or less. In addition, the aluminum plate may be an aluminum plate made of an aluminum ingot used in a DC casting method or an aluminum plate made of an ingot by a continuous casting method. In the aluminum plate, materials which are well-known and frequently used in the related art, for example, JIS A 1050, JIS A 1100, JIS A 3103, and JIS A 3005, can be appropriately used.

The thickness of the substrate is generally 0.05 mm to 0.6 mm, preferably 0.1 mm to 0.4 mm, and particularly preferably 0.15 mm to 0.3 mm.

In general, an aluminum plate for a lithographic printing plate precursor is produced by a degreasing step of removing rolling oil attached to an aluminum plate, a desmut process step of dissolving and removing a smut on a surface of the aluminum plate, and a roughening process step of roughening a surface of the aluminum plate.

Specifically, with respect to the aluminum plate, a dissolving process is performed by using an alkali aqueous solution such as caustic soda in order to remove a strong stain or a naturally oxidized coating film. In order to neutralize a remaining alkaline component after the process, a neutralizing treatment of immersing the aluminum plate in an acid such as a phosphoric acid, a nitric acid, a sulfuric acid, a hydrochloric acid, and a chromic acid, or a mixed acid thereof is performed. If necessary, in order to remove oils, fats, rust, and dust on the surface of the aluminum plate, a solvent degreasing process due to trichloroethylene and thinner, and an emulsion degreasing process using emulsion such as kerosene and triethanol may be performed.

When an electrochemical roughening process described below is performed after a dissolving process using an alkali aqueous solution or a neutralizing treatment due to acid, types and compositions of acid used in the neutralizing treatment is preferably matched with types and compositions of acid used in the electrochemical roughening process.

The roughening process of the surface of the aluminum plate is performed by various methods. Examples thereof include a method a mechanically roughening a surface, a method of electrochemically dissolving and roughening a surface, a method of selectively dissolving a surface in a chemical manner, and a combination of these methods.

As a mechanical roughening method, well-known methods such as ball graining, brush graining, blast graining, and buff graining method can be used. As a chemical roughening method, a method of immersing an aluminum plate in a saturated aqueous solution of an aluminum salt of a mineral acid as disclosed in JP1979-31187A (JP-S54-31187A) is preferable. There is an electrochemical roughening method that is performed by an alternating current or a direct current including acid such as a hydrochloric acid or a nitric acid in an electrolyte. In addition, an electrolysis chemical roughening method using a mixed acid as disclosed in JP1979-63902A (JP-S54-63902A) can be used.

It is preferable that the roughening is performed in a range in which the central line average roughness (Ra) on the surface of the aluminum plate is 0.2 μm to 1.0 μm.

If necessary, with respect to the roughened aluminum plate, an alkali etching process is performed by using an aqueous solution of potassium hydroxide or sodium hydroxide, and further, a neutralizing treatment is performed.

According to the invention, it is preferable that a hydrophilic film is provided on an aluminum plate subjected to the roughening process as described above and another process, if necessary. Particularly, a support provided with a hydrophilic film having density of 1,000 kg/m³ to 3,200 kg/m³ has satisfactory coating film strength and stain resistance in printing, and also satisfactory heat insulating properties of preventing the diffusion of heat generated in the image recording layer to the support, and thus the support is suitable.

The measurement of the density can be calculated by the following equation, for example, from a mass of hydrophilic layer according to Mason's method (obtaining a mass of a hydrophilic film by dissolving hydrophilic film by a mixed solution of chromic acid/phosphoric acid) and a thickness of a hydrophilic film obtained by observing a cross section by a scanning electron microscope (SEM).

Density (kg/m³)=(hydrophilic film mass per unit area)/film thickness

When hydrophilic film density is less than 1,000 kg/m³, a coating film strength decreases, it is likely that the decrease may adversely influence on image forming properties, printing durability, or the like, and it is likely that stain resistance in printing is deteriorated. If hydrophilic film density is greater than 3,200 kg/m³, sufficient heat insulation properties are not obtained, and thus it is likely that a sensitivity enhancing effect may decrease.

A method of providing a hydrophilic film is not particularly limited, and an anodic oxidation method, an vapor deposition method, a CVD method, a sol-gel method, a sputtering method, an ion plating method, a diffusion method, and the like can be appropriately used. In addition, a method of applying a solution obtained by mixing hollow particles with a hydrophilic resin or a sol-gel solution can be used.

Particularly, a process of manufacturing an oxide coating film by an anodic oxidation method, that is, an anodic oxidation process, is particularly suitably used. The anodic oxidation process can be performed by a method that is performed in the related art.

Specifically, in an aqueous solution or a non-aqueous solution of a single substance or a combination of two or more types of a sulfuric acid, a phosphoric acid, a chromic acid, an oxalic acid, a sulfamic acid, and a benzenesulfonic acid, if a direct current or an alternating current is caused to flow to an aluminum plate, an anodic oxidation coating film which is a hydrophilic coating film can be formed on the surface of the aluminum plate.

The condition of the anodic oxidation process changes in various manners depending on used electrolytes, and thus it may not be specified in an unconditional manner, but generally, electrolyte concentration of 1% to 80%, a solution temperature of 5° C. to 70° C., electric current density of 0.5 A/dm² to 60 A/dm², an electric voltage of 1 V to 200 V, and electrolysis time of 1 second to 1000 seconds are appropriate.

Among anodic oxidation processes, a method of performing an anodic oxidation process in a high electric current density in an electrolyte of an sulfuric acid disclosed in GB1412768B, a method of performing an anodic oxidation process with a phosphoric acid as an electrotylic bath disclosed in U.S. Pat. No. 3,511,661A, and the like are preferable. In addition, a multistage anodic oxidation process of performing an anodic oxidation process in a sulfuric acid and further performing an anodic oxidation process in a phosphoric acid may be performed.

In the invention, in view of effectively preventing a damage of a non-image portion to cause a stain, the amount of the anodic oxidation coating film is preferably 1.5 g/m² or greater.

As the support, an aluminum plate that is roughening-processed as above and that has an anodic oxidation coating film may be used without change, but in order to further improve bonding properties with an upper layer, hydrophilicity, stain resistance, heat insulation properties, and the like, if necessary, an enlarging process of micropores and a sealing process of micropores on an anodic oxidation coating film disclosed in JP2001-253181A and JP2001-322365A and a surface hydrophilization process with alkali metal silicate disclosed in U.S. Pat. No. 2,714,066A, U.S. Pat. No. 3,181,461A, U.S. Pat. No. 3,280,734A, and U.S. Pat. No. 3,902,734A and polyvinyl phosphonate and the like disclosed in U.S. Pat. No. 3,276,868A, U.S. Pat. No. 4,153,461A, and U.S. Pat. No. 4,689,272A can be appropriately selected to be performed.

In addition, if necessary, for example, an inorganic undercoat layer or an organic undercoat layer of water-soluble metal salt such as zinc borate may be provided. Examples of the organic compound used in the organic undercoat layer include a polymer and a copolymer having carboxymethyl cellulose, dextrin, gum arabic, and a sulfonic acid group in a side chain, a phosphonic acid having an amino group such as a polyacrylic acid and a 2-aminoethylphosphonic acid, an organic phosphonic acid that may have a substituent such as a phenylphosphonic acid, a naphtylphosphonic acid, an alkyl phosphonic acid, a glycerophosphonic acid, a methylene diphosphonic acid, and an ethylene diphosphonic acid, an organic phosphoric acid that may have a substituent such as a phenylphosphoric acid, a naphtylphosphoric acid, an alkyl phosphoric acid, and a glycerophosphoric acid, an organic phosphinic acid that may have a substituent such as a phenylphosphinic acid, a naphtylphosphinic acid, an alkyl phosphinic acid, and a glycerophosphinic acid, an amino acid such as glycine or 3-alanine, hydrochloric acid salts of amine having a hydroxyl group such as a hydrochloric acid salt of triethanolamine, and yellow dye. Two or more types of these organic compounds may be used in combination.

The organic undercoat layer can be provided in the following methods. That is, an organic compound is dissolved in water or an organic solvent such as methanol, ethanol, and methyl ethyl ketone or a mixed solvent thereof such that the density thereof becomes 0.005% by weight to 10% by weight, so as to prepare a coating liquid, and this coating liquid is applied to a support such as an aluminum plate and is dried so as to form an undercoat layer. The application is performed in various ways. For example, all methods of bar coater coating, rotary coating, spray coating, and curtain coating may be used. A coating amount of the organic undercoat layer after drying is suitably 2 mg/m² to 200 mg/m², and preferably 5 mg/m² to 100 mg/m². In this range, satisfactory printing durability can be obtained. A photothermal converting agent may be contained in the undercoat layer.

If necessary, a back coating layer including organic high molecular compounds disclosed in JP1993-45885A (JP-H5-45885A), alkoxy compounds of silicon disclosed in JP1994-35174A (JP-H6-35174A), and the like may be provided on the back surface of the support, if necessary.

[Protective Layer]

The lithographic printing plate precursor according to the invention may be provided with a protective layer (overcoat layer) on an image recording layer. The protective layer has a function of protecting a surface of a hydrophilic image recording layer from contamination due to lipophilic materials at the time of preservation, contamination due to fingerprints by the contact with a finger at the time of handling, or the like, a function of preventing a scratch in the image recording layer and preventing ablation at the time of high illuminance laser exposure, a function of suppressing response to inhibition of image forming due to oxygen blocking, and the like.

The overcoat layer can be easily removed from the printing machine, any one of a water-soluble polymer and a water-swelling polymer obtained by partially crosslinking a water-soluble polymer can be appropriately selected to be used, and two or more types thereof may be used in combination.

The water-soluble polymer is selected from a water-soluble natural polymer and a water-soluble synthetic polymer, and the water-soluble polymer may be used singly or together with a crosslinking agent such that a coating film after coating and drying has film forming properties.

As specific examples of the water-soluble polymer, examples of the natural polymer include gum arabic, water-soluble soybean polysaccharide, fibrous derivative (for example, carboxymethyl cellulose, carboxyethyl cellulose, methyl cellulose), a modified product thereof, white dextrin, pullulan, and enzyme degradation etherified dextrin, and examples of the synthetic polymer include polyvinyl alcohol (having a hydrolysis degree of polyvinyl acetate of 65% or higher), modified polyvinyl alcohol (acid modified polyvinyl alcohol having a carboxyl group or a sulfo group is preferably used. Specifically, examples thereof suitably include modified polyvinyl alcohol disclosed in JP2005-250216A and JP2006-259137A.), polyvinyl pyrrolidone, poly(meth)acrylonitrile, polyacrylic acid, an alkali metal salt or an amine salt thereof, a polyacrylic acid copolymer, an alkali metal salt or an amine salt thereof, an polymethacrylic acid, an alkali metal salt or an amine salt thereof, a vinyl alcohol/acrylic acid copolymer, an alkali metal salt or an amine salt thereof, polyacrylamide, a copolymer thereof, polyhydroxyethyl acrylate, polyvinylmethyl ether, a vinylmethyl ether/maleic anhydride copolymer, poly-2-acrylamide-2-methyl-1-propane sulfonic acid, an alkali metal salt or an amine salt thereof, a poly-2-acrylamide-2-methyl-1-propane sulfonic acid copolymer, an alkali metal salt or an amine salt thereof, and polymers disclosed in U.S. Pat. No. 3,458,311A and JP1980-49729B (JP-S55-49729B).

If an overcoat layer is formed on the image recording layer by partially crosslinking at least one type of the water-soluble polymer, the crosslinking is performed by performing crosslink reaction by using a reactive functional group having a water-soluble polymer. The crosslinking reaction may be covalent bond crosslinking or may be ion bond crosslinking.

Adhesiveness of the surface of the overcoat layer decreases by crosslinking and thus handling properties of the lithographic printing plate precursor are enhanced, but, if crosslinking is performed too intensively, the overcoat layer becomes lipophilic, and thus the removing of the overcoat layer on the printing machine tends to become difficult, and thus moderate partial crosslinking is preferable. The degree of preferable partial crosslinking is a degree in which, when a lithographic printing plate precursor is immersed in water at 25° C., the overcoat layer is not eluted for a period of time of 30 seconds to 10 minutes and remains, but the elution of the overcoat layer is acknowledged for a period of time of 10 minutes or longer.

Examples of the compound (crosslinking agent) used in the crosslinking reaction include a well-known multifunctional compound having crosslinking properties, and specific examples thereof include a polyepoxy compound, a polyamine compound, a polyisocyante compound, a polyalkoxysilyl compound, a titanate compound, an aldehyde compound, a polyvalent metal salt compound, and hydrazine.

The crosslinking agent may be used singly or two or more types thereof may be used in combination. A particularly preferable crosslinking agent is a water-soluble crosslinking agent, but the water-insoluble crosslinking agent may be dispersed in water depending on the dispersing agent to be used.

Examples of the preferable combination of a water-soluble resin and a crosslinking agent include a carboxylic acid-containing water-soluble resin/a polyvalent metallic compound, a carboxylic acid-containing water-soluble resin/a water-soluble epoxy resin, and a hydroxy group-containing resin/dialdehydes.

The suitable addition amount of the crosslinking agent is 2% to 10% of a water-soluble resin. In this range, satisfactory handling properties can be obtained without deteriorating removability of the overcoat layer on the printing machine.

The protective layer may contain well-known additives such as a plasticizer that provides flexibility, a surfactant that enhances coating properties, inorganic fine particles that control slippage of a surface, and the like. In addition, the sensitizer described in the description of the image recording layer may be contained in the protective layer.

The protective layer is coated in the well-known method. The coating amount of the protective layer is preferably 0.01 g/m² to 10 g/m², and more preferably 0.02 g/m² to 3 g/m², and particularly preferably 0.02 g/m² to 1 g/m² in terms of the coating amount after drying.

[Method for Producing Plate]

The method for producing the lithographic printing plate precursor according to the invention is described below.

The lithographic printing plate precursor according to the invention is produced by performing development on the printing machine after image exposure, to be used in printing.

The image exposure is performed by laser exposure or laser light scanning with digital data through a transparent source image having a linear image, a halftone dot image, and the like. A light source having a wavelength of 700 nm to 1400 nm is preferably used. As the light source having a wavelength of 700 nm to 1400 nm, a solid laser and a semiconductor laser that radiate infrared rays are suitable. With respect to the infrared ray laser, an output thereof is preferably 100 mW or greater, the exposure time per one pixel is preferably within 20 microseconds, and an irradiation energy amount is preferably 10 mJ/cm² to 300 mJ/cm². In order to reduce the exposure time, a multibeam laser device is preferably used. The exposure mechanism may be any one of an internal drum type, an external drum type, or a flat bed type. The image exposure may be performed by well-known methods by using a plate setter.

The image-exposed lithographic printing plate precursor is subjected to on-board development by a normal printing starting operation of supplying dampening water and ink after attached to an impression cylinder of a printing machine, and can continuously perform printing.

When an exposure device is mounted on a printing machine, after the lithographic printing plate precursor is installed on a plate cylinder of the printing machine, exposure is performed by the exposure device of the printing machine, on-board development is continuously performed, and printing can be performed.

According to the invention, a plate producing method of removing an unexposed portion of the image recording layer by using at least one of printing ink and dampening water on the printing machine, after the lithographic printing plate precursor described above is image-exposed with infrared ray laser, is preferable.

### EXAMPLES

Hereinafter, the invention is described in detail with reference to examples, but the invention is not limited thereto. In addition, unless being specified otherwise for the high molecular compound, a molecular weight is a mass average molar mass (Mw), and a ratio of a repeating unit is a mole percentage.

### Examples 1 to 15 and Comparative Examples 1 to 4

### Production of Lithographic Printing Plate Precursor

(Production of Support)

Degreasing was performed by immersing an aluminum plate having a thickness of 0.19 mm at 60° C. for 8 seconds, in a sodium hydroxide aqueous solution of 40 g/l, and washing was performed for 2 seconds with demineralized water. Subsequently, an electrochemical roughening process was performed on an aluminum plate for 15 seconds by using an alternating current, at a temperature of 33° C. and an electric current density of 130 A/dm², in an aqueous solution of containing a hydrochloric acid of 12 g/l and aluminum sulfate of 38 g/l (18 hydrate). After washing was performed for 2 seconds with demineralized water, an aluminum plate was subjected to a desmut process by etching the aluminum plate for 4 seconds at 70° C. in a sulfuric acid aqueous solution of 155 g/l, and washing was performed for 2 seconds at 25° C. with demineralized water. The aluminum plate was subjected to an anodic oxidation process at a temperature of 45° C. and electric current density of 22 A/dm² for 13 seconds in the sulfuric acid aqueous solution of 155 g/l, and the aluminum plate was washed for 2 seconds with demineralized water. Further, a post process was performed for 10 seconds at 40° C. by using a polyvinylphosphonic acid aqueous solution of 4 g/l, washing was performed for 2 seconds at 20° C. with demineralized water, and drying was performed. The support that was obtained in this manner had a surface roughness Ra of 0.21 μm and an anodic oxidation coating film amount of 4 g/m².

(Production of Lithographic Printing Plate Precursor)

An aqueous coating liquid for an image recording layer containing components such as a thermoplastic fine particle polymer, an infrared ray absorption agent, and a polyglycerol compound as described in Table 1 below was prepared, pH thereof was adjusted to 3.6, the aqueous coating liquid was applied to the support, drying was performed for 1 minute at 50° C., and an image recording layer was formed such that a lithographic printing plate precursor was produced. The application amounts of respective components are presented in Table 1.

TABLE 1

| Coating | | | | | | | | | Surfactant having | |
|---|---|---|---|---|---|---|---|---|---|---|
| liquid for | Thermoplastic fine | | Infrared ray | | Polyglycerol | | | | POA group or | |
| image | particle polymer | | absorption agent | | compound | | Other components | | hydroxy group | |
| recording | | Coating | | Coating | | Coating | | Coating | | Coating |
| layer | Type | amount (g/m²) | Type | amount (g/m²) | Type | amount (g/m²) | Type | amount (g/m²) | Type | amount (g/m²) |
| T-1 | SAN | 0.7 | IR-01 | 1.20 × 10⁻⁴ | PG-1 | 0.09 | — | — | — | — |
| T-2 | SAN | 0.7 | IR-01 | 1.20 × 10⁻⁴ | PG-1 | 0.18 | — | — | — | — |
| T-3 | SAN | 0.7 | IR-01 | 1.20 × 10⁻⁴ | PG-1 | 0.01 | — | — | — | — |
| T-4 | SAN | 0.7 | IR-01 | 1.20 × 10⁻⁴ | PG-2 | 0.09 | — | — | — | — |
| T-5 | SAN | 0.7 | IR-01 | 1.20 × 10⁻⁴ | PG-3 | 0.09 | — | — | — | — |
| T-6 | SAN | 0.7 | IR-01 | 1.20 × 10⁻⁴ | PG-1 | 0.09 | — | — | A-3 | 0.008 |
| T-7 | SAN | 0.7 | IR-01 | 1.20 × 10⁻⁴ | PG-1 | 0.07 | — | — | A-3 | 0.008 |
| T-8 | SAN | 0.7 | IR-01 | 1.20 × 10⁻⁴ | PG-1 | 0.07 | — | — | A-4 | 0.008 |
| T-9 | SAN | 0.7 | IR-01 | 1.20 × 10⁻⁴ | PG-1 | 0.07 | — | — | A-6 | 0.008 |
| T-10 | SAN | 0.7 | IR-01 | 1.20 × 10⁻⁴ | PG-1 | 0.07 | — | — | A-10 | 0.008 |
| T-11 | SAN | 0.7 | IR-01 | 1.20 × 10⁻⁴ | PG-1 | 0.07 | — | — | N-1 | 0.008 |
| T-12 | SAN | 0.7 | IR-01 | 1.20 × 10⁻⁴ | PG-1 | 0.07 | — | — | N-2 | 0.008 |
| T-13 | SAN | 0.7 | IR-01 | 1.20 × 10⁻⁴ | PG-1 | 0.07 | — | — | N-6 | 0.008 |
| T-14 | SAN | 0.7 | IR-01 | 1.20 × 10⁻⁴ | PG-1 | 0.07 | — | — | N-11 | 0.008 |
| T-15 | SAN | 0.7 | IR-01 | 1.20 × 10⁻⁴ | PG-1 | 0.07 | — | — | N-12 | 0.008 |
| S-1 | SAN | 0.7 | IR-01 | 1.20 × 10⁻⁴ | — | — | — | — | — | — |
| S-2 | SAN | 0.7 | IR-01 | 1.20 × 10⁻⁴ | — | — | PAA | 0.09 | — | — |
| S-3 | SAN | 0.7 | IR-01 | 1.20 × 10⁻⁴ | — | — | (X) | 0.07 | — | — |
| S-4 | SAN | 0.7 | IR-01 | 1.20 × 10⁻⁴ | — | — | — | — | A-3 | 0.008 |

A thermoplastic fine particle polymer SAN, an infrared ray absorption agent IR-01, polyglycerol compounds PG-1 to PG-3, a surfactant containing a POA group or a hydroxy group N-12, and other components PAA and (X), which are used in the coating liquid for the image recording layer, are as described below. In addition, among surfactants containing the POA group or the hydroxy group, surfactants except for a surfactant N-12 are the surfactant described above.

Thermoplastic fine particle polymer SAN: Styrene/acrylonitrile copolymer (molar ratio: 50/50), Tg: 99° C., Average particle diameter: 60 nm Polyglycerol compound PG-1: Polyglycerin PGL 10 (the number of repeating units: 10) (manufactured by DAICEL Corporation)

Polyglycerol compound PG-2: Polyglycerin PGL 6 (the number of repeating units: 6) (manufactured by DAICEL Corporation)

Polyglycerol compound PG-3: Polyglycerin PGL X (the number of repeating units: 40) (manufactured by DAICEL Corporation)

Surfactant N-12 containing POA group or hydroxy group: Polyether modified polydimethylsiloxane (Product name EDAPLAN LA411 manufactured by The Dow Chemical Company)

Another component PAA: polyacrylic acid, mass average molecular weight: 250,000

Another component (X): Decaglycerin monolaurate (Product name POEM J-0021 manufactured by RIKEN VITAMIN CO., LTD.)

Infrared ray absorption agent IR-01: infrared ray absorption agent having the following structure

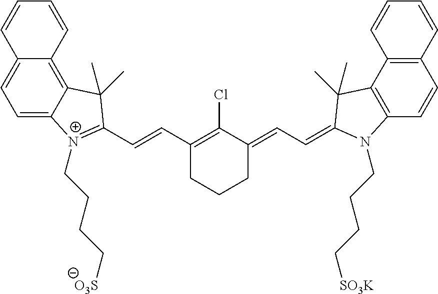

[Evaluation of Lithographic Printing Plate Precursor]

With respect to respective lithographic printing plate precursors, on-board developability and printing durability are evaluated as follows. The evaluation was performed by using a lithographic printing plate precursor right after the production and lithographic printing plate precursors which were forced to be left over time according to Thermoconditions 1 and 2 as below.

<Thermocondition 1>

The produced lithographic printing plate precursors and interleaving paper (interleaving paper disclosed in Example 1 of JP2003-302749A (corresponding to EP1353221B1) were humidified for one hour in the conditions of 25° C. and 50% RH. After humidification, 30 sets of interleaving paper mounted on a lithographic printing plate precursor were stacked and packaged with aluminum craft paper in a state in which upper portions and lower portions thereof were matched and balls were interposed, so as to produce a normal product shape. A lithographic printing plate precursor which simulates a case of being preserved for a long period of time in a condition of high temperature by storing the produced package at 60° C. for 4.5 days was produced.

<Thermocondition 2>

The produced lithographic printing plate precursors and interleaving paper (interleaving paper disclosed in Example 1 of JP2003-302749A (corresponding to EP1353221B1)) were humidified for one hour in the conditions of 25° C. and 85% RH. After humidification, 30 sets of interleaving paper mounted on a lithographic printing plate precursor were stacked and packaged with aluminum craft paper in a state in which upper portions and lower portions thereof were matched and balls were interposed, so as to produce a normal product shape. A lithographic printing plate precursor which simulates a case of being preserved for a long period of time in a hot and humid condition by storing the produced package at 60° C. for 4.5 days was produced.

(On-Board Developability)

The lithographic printing plate precursor was exposed in the conditions of external drum rotation speed of 1,000 rpm, a laser output of 70%, and a resolution of 2,400 dpi by Luxel PLATESETTER T-6000III on which an infrared ray semiconductor laser was mounted and which was manufactured by FUJIFILM Corporation. The exposure image was caused to include a solid image and a 50% halftone dot chart of a 20 μm dot FM screen.

The lithographic printing plate precursor after exposure was attached to a plate cylinder of a printing machine LITHRONE26 manufactured by Komori Corporation without being subjected to a development process. Dampening water of Ecolity-2 (manufactured by Fujifilm Corporation)/tap water=2/98 (capacity ratio) and SPACE COLOR FUSION G(N) ink (manufactured by DIC Graphics Corporation) were used, and dampening water and ink were supplied in a standard automatic printing start method of LITHRONE26, on-board development was performed, and printing was performed on 100 sheets of TOKUBISHI ART (76.5 kg) paper in a printing speed of 10,000 sheets per hour.

On-board development on the printing machine of an unexposed portion of the image recording layer was completed, and a required number of sheets of printing paper until ink is not transferred to a non-image portion were counted and were evaluated as on-board developability. The results are presented in Table 2.

(Printing Durability)

After the on-board developability evaluation was performed, printing was continued.

When the number of printing increased, the image recording layer was gradually worn out and thus ink density on a printed matter decreased. The number of prints when a value obtained by measuring a halftone dot area ratio of a 50% halftone dot of an FM screen on the printed matter with a GRETAG densitometer was decreased from a measured value of the 100-th sheets of printing by 5% were counted and were evaluated as printing durability. The results are presented in Table 2.

TABLE 2

| | Coating | | | | | | |
|---|---|---|---|---|---|---|---|
| | liquid for | On-board developability (sheets) | | | Printing durability (Ten thousand sheets) | | |
| | image | Before | | | Before | | |
| | recording | elapse of | After elapse of time | | elapse of | After elapse of time | |
| | layer | time | Thermocondition 1 | Thermocondition 2 | time | Thermocondition 1 | Thermocondition 2 |
| Example 1 | T-1 | 15 | 15 | 30 | 3.0 | 3.0 | 2.8 |
| Example 2 | T-2 | 15 | 15 | 25 | 3.0 | 3.0 | 2.8 |
| Example 3 | T-3 | 15 | 20 | 35 | 3.0 | 2.8 | 2.5 |
| Example 4 | T-4 | 15 | 15 | 25 | 3.0 | 3.0 | 2.8 |
| Example 5 | T-5 | 15 | 15 | 30 | 3.0 | 3.0 | 2.8 |
| Example 6 | T-6 | 10 | 10 | 15 | 3.3 | 3.3 | 3.0 |
| Example 7 | T-7 | 10 | 15 | 20 | 3.3 | 3.3 | 3.0 |
| Example 8 | T-8 | 7 | 10 | 20 | 3.3 | 3.3 | 3.0 |
| Example 9 | T-9 | 7 | 10 | 15 | 3.5 | 3.5 | 3.5 |
| Example 10 | T-10 | 10 | 10 | 15 | 3.5 | 3.5 | 3.3 |
| Example 11 | T-11 | 10 | 15 | 20 | 3.3 | 3.3 | 3.0 |
| Example 12 | T-12 | 15 | 15 | 20 | 3.5 | 3.5 | 3.3 |
| Example 13 | T-13 | 15 | 15 | 25 | 3.3 | 3.3 | 3.0 |
| Example 14 | T-14 | 15 | 15 | 25 | 3.3 | 3.3 | 3.0 |
| Example 15 | T-15 | 15 | 15 | 20 | 3.3 | 3.3 | 3.0 |
| Comparative | S-1 | >100 | >500 | >500 | *1 | *1 | *1 |
| Example 1 | | | | | | | |
| Comparative | S-2 | 20 | 25 | >500 | 3.0 | 2.8 | *1 |
| Example 2 | | | | | | | |
| Comparative | S-3 | 25 | 40 | >100 | 3.0 | 2.5 | *1 |
| Example 3 | | | | | | | |
| Comparative | S-4 | 15 | 20 | >100 | 3.3 | 3.0 | *1 |
| Example 4 | | | | | | | |

In Table 2, *1 indicates that, since on-board development was not sufficiently proceeded, ink was attached to the non-image portion and generates stains, and thus evaluation of printing durability was not possible.

As clearly understood from the results presented in Table 2, on-board developability was extremely enhanced by causing the polyglycerol compound according to the invention to be contained in the image recording layer of the thermal fusion-type lithographic printing plate precursor (Examples 1 to 5). In addition, excellent on-board developability was maintained by using the surfactant containing the polyoxyalkylene group and the hydroxy group together even when being preserved in a hot condition or a hot and humid condition (Examples 6 to 15).

In contrast, when the image recording layer does not contain a polyglycerol compound (Comparative Example 1), on-board developability was extremely deteriorated. In addition, if a well-known water-soluble resin such as a polyacrylic acid was contained (Comparative Example 2), or polyglycerol ester having a long chain alkyl group such as decaglycerin monolaurate was contained (Comparative Example 3), on-board developability was greatly deteriorated.

Further, the image recording layer did not contain polyglycerol compound and the surfactant having the polyoxyalkylene group or the hydroxy group was only contained (Comparative Example 4), on-board developability was greatly decreased.

As above, it is understood that the polyglycerol compound according to the invention is particularly effective in enhancement of on-board developability of the thermal fusion-type lithographic printing plate precursor.

### INDUSTRIAL APPLICABILITY

According to the invention, it is possible to obtain a thermal fusion-type lithographic printing plate precursor having extremely excellent on-board developability while maintaining printing durability. Also, it is possible to obtain a thermal fusion-type lithographic printing plate precursor having excellent preservation stability.

The invention was described in detail with reference to specific embodiments, but it is clear to a person skilled in the art that various modifications and changes can be made without departing from the gist and the scope of the invention.

This application is based on Japanese patent application (JP2013-149861) filed on Jul. 18, 2013, and the entire contents thereof are incorporated herein by reference.

What is claimed is:

1. A lithographic printing plate precursor comprising, on a support:
an image recording layer containing
(A) a thermoplastic fine particle polymer,
(B) an infrared ray absorption agent, and
(C) a polyglycerol compound,
wherein the polyglycerol compound is a compound having three or more structural units selected from structural units expressed by the following General Formulae (1) and (2), 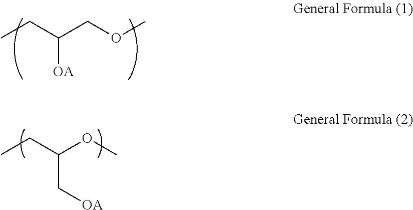
where, in General Formulae (1) and (2), A represents a hydrogen atom, an alkyl group having 1 to 4 carbon atoms, or an alkyl carbonyl group having 2 to 5 carbon atoms.

2. The lithographic printing plate precursor according to claim 1,
wherein A in the structural units expressed by General Formulae (1) and (2) is a hydrogen atom.

3. The lithographic printing plate precursor according to claim 1,
wherein the image recording layer contains a surfactant having a polyoxyalkylene group or a hydroxy group.

4. The lithographic printing plate precursor according to claim 2,
wherein the image recording layer contains a surfactant having a polyoxyalkylene group or a hydroxy group.

5. The lithographic printing plate precursor according to claim 3,
wherein the surfactant having the polyoxyalkylene group or the hydroxy group is an anionic surfactant or a nonionic surfactant which has a polyoxyalkylene group or a hydroxy group.

6. The lithographic printing plate precursor according to claim 4,
wherein the surfactant having the polyoxyalkylene group or the hydroxy group is an anionic surfactant or a nonionic surfactant which has a polyoxyalkylene group or a hydroxy group.

7. The lithographic printing plate precursor according to claim 5,
wherein the anionic surfactant or the nonionic surfactant having the polyoxyalkylene group or the hydroxy group is an anionic surfactant or a nonionic surfactant which has a polyoxyalkylene group.

8. The lithographic printing plate precursor according to claim 6,
wherein the anionic surfactant or the nonionic surfactant having the polyoxyalkylene group or the hydroxy group is an anionic surfactant or a nonionic surfactant which has a polyoxyalkylene group.

9. The lithographic printing plate precursor according to claim 7,
wherein the anionic surfactant or the nonionic surfactant having the polyoxyalkylene group is an anionic surfactant or a nonionic surfactant which has a polyoxyethylene group.

10. The lithographic printing plate precursor according to claim 8,
wherein the anionic surfactant or the nonionic surfactant having the polyoxyalkylene group is an anionic surfactant or a nonionic surfactant which has a polyoxyethylene group.

11. A method for producing a plate comprising:
image-exposing the lithographic printing plate precursor according to claim 1, with an infrared ray laser; and
removing an unexposed portion of the image recording layer by using at least one of printing ink and dampening water on a printing machine.
